(19) United States
(12) Patent Application Publication
(10) Pub. No.: US 2010/0087617 A1
(43) Pub. Date: Apr. 8, 2010

(54) COMPOSITION CAPABLE OF FORMING YELLOWING-FREE, LOW-HARDNESS POLYURETHANE ELASTOMER, AND METHOD FOR PRODUCING YELLOWING-FREE, LOW-HARDNESS POLYURETHANE ELASTOMER USING THE SAME

(75) Inventors: Teppei Oyanagi, Tokyo (JP); Takahiro Aizawa, Tokyo (JP)

Correspondence Address: K&L Gates LLP, P.O. Box 1135, CHICAGO, IL, 60690, US

(73) Assignee: NIPPON POLYURETHANE INDUSTRY CO., LTD., TOKYO (JP)

(21) Appl. No.: 12/531,511

(22) PCT Filed: Mar. 14, 2008
(86) PCT No.: PCT/JP2008/000583

§ 371 Date: Nov. 18, 2009

(30) Foreign Application Priority Data
Mar. 16, 2007 (JP) P2007-067698

(51) Int. Cl. C08G 18/42; C08G 18/10

(52) U.S. Cl. 528/66

(57) ABSTRACT

The present invention provides a thermosetting polyurethane elastomer that is yellowing-free, has low hardness and does not give rise to bleeding without using any plasticizer, has little tack, and exhibits small changes in hardness with temperature.

This is achieved by a composition forming a yellowing-free, low-hardness polyurethane elastomer, containing no plasticizer and having (A) an isocyanate-terminated prepolymer and (B) a polyester polyol, wherein the isocyanate-terminated prepolymer (A) is an isocyanate-terminated prepolymer obtained by reacting hexamethylene diisocyanate with a glycol having an alkyl group as a side chain and having a molecular weight no greater than 500, and the polyester polyol (B) is a polyester polyol obtained from trimethylolpropane, 3-methyl-1,5-pentanediol and adipic acid, and having an average number of functional groups of 2.5 to 3.5 and a number average molecular weight of 800 to 5,000.

### TECHNICAL FIELD

The present invention relates to a composition forming a yellowing-free, low-hardness polyurethane elastomer, and to a method for producing a yellowing-free, low-hardness polyurethane elastomer using the same.

### BACKGROUND ART

Thermosetting polyurethane elastomers have excellent mechanical characteristics and rubber-like elasticity, and can also be adjusted so as to exhibit arbitrary properties. For this reason, thermosetting polyurethane elastomers are used in various rollers for office automation equipment, for instance charging rollers, developing rollers, transfer rollers, paper feed rollers and the like used in copiers, fax machines or the like, as well as in shock absorbing members for office automation equipment, buffer members for optical materials, surface protection members in labels and displays, automotive components, various general merchandise, sports articles, vibration proofing and seismic isolation materials, medical mats, shoe insoles, supporters and the like.

In the fields of packings, vibration-proof and seismic isolation materials, shock absorbing materials, buffer members, surface protection members and the like, thermosetting polyurethane elastomers must exhibit low hardness (Asker C hardness no greater than 30), low compression set, excellent dimensional stability, transparency and non-yellowing properties, as well as little bleeding or tacky feel.

There are methods that rely on adding substantial amounts of plasticizer to obtain low-hardness thermosetting polyurethane elastomers, but such methods tend to result in poorer mechanical characteristics, increased compression set, surface contamination on account of plasticizer bleeding, as well as property variations over time, among other problems. Another method involves lowering cross-linking density by using starting materials having few functional groups. This approach, however, gives rise to problems such as increased compression set and impaired mechanical characteristics.

Various thermosetting polyurethane elastomers have been proposed that exhibit low hardness, low compression set, good moldability, and are also bleeding-free.

Patent document 1 discloses a molded article of a thermosetting flexible polyurethane elastomer obtained from a compound containing active hydrogen group which consists mainly of a high-molecular weight polyfunctional polypropylene glycol, and from an isocyanate-terminated prepolymer obtained by reacting diphenylmethane diisocyanate and/or carbodiimide-modified diphenylmethane diisocyanate with polypropylene glycol having a high molecular weight and an average functionality of 3 to 6. Patent document 2 discloses a method for producing a thermosetting polyurethane elastomer molded article using no plasticizer, by reacting an isocyanate-terminated prepolymer, obtained by reacting tolylene diisocyanate with a polyoxyalkylene polyol having a high molecular weight, an average hydroxyl number of 2 to 3 and a total unsaturation degree no greater than 0.07 meq/g, with a polyoxyalkylene polyol having a high molecular weight and an average hydroxyl number of 2 to 3.

Patent document 1: JP No. H08-151423

Patent document 2: JP No. 2003-252947

In Patent document 1, however, the isocyanate-terminated prepolymer containing a high molecular weight polyfunctional polypropylene glycol as a main component, exhibits high viscosity, and is prone to give rise to the following problems.
The composition uses diphenylmethane diisocyanate, and undergoes yellowing as a result.
Workability during injection molding is poor.
Molding defects are prone to occur.

Also, the composition uses a low-activity polyoxypropylene glycol, which tends to give rise to the following problems.
The reaction is slow, and hence molding must be carried out at a comparatively high mold temperature.
Residual unreacted polyoxypropylene glycol is likely to result in bleeding.

Meanwhile, the technology disclosed in Patent document 2 is apt to suffer from the following problems.
The composition uses tolylene diisocyanate, and undergoes yellowing as a result.
The reaction between the isocyanate-terminated prepolymer with the compound containing active hydrogen groups is slow, and the residual unreacted polyol is likely to give rise to bleeding.
Molding must be carried out at a comparatively high mold temperature in order to increase curing speed.
Attempts at lowering hardness are likely to exacerbate tacky feel.

### DISCLOSURE OF THE INVENTION

### Problems to be Solved by the Invention

It is an object of the present invention to provide a thermosetting polyurethane elastomer that is yellowing-free, has low hardness without using any plasticizer, has bleedless, has little tack, and exhibits small changes in hardness with temperature.

### Means for Solving the Problems

As a result of diligent research directed at solving the above problems, the inventors perfected the present invention upon finding that the problems are solved by way of the below-described composition forming a polyurethane elastomer.

Specifically, the present invention encompasses aspects (1) to (4) below.

(1) A composition capable of forming a yellowing-free, low-hardness polyurethane elastomer, which contains no plasticizer and comprises (A) an isocyanate-terminated prepolymer and (B) a polyester polyol as essential components,

wherein the isocyanate-terminated prepolymer (A) is an isocyanate-terminated prepolymer that is obtained by reacting hexamethylene diisocyanate with a glycol having an alkyl group as a side chain and having a molecular weight no greater than 500, and that has an average number of functional groups of 2.5 to 6, and

the polyester polyol (B) is a polyester polyol that is obtained from trimethylolpropane, 3-methyl-1,5-pentanediol and adipic acid, and has an average number of functional groups of 2.5 to 3.5 and a number average molecular weight of 800 to 5,000.

(2) The composition forming a yellowing-free, low-hardness polyurethane elastomer according to (1), wherein the isocyanate-terminated prepolymer (A) is an isocyanate-terminated urethane-isocyanurate prepolymer obtained by a urethanation reaction and an isocyanuration reaction between hexamethylene diisocyanate and a glycol having an alkyl group as a side chain and having a molecular weight no greater than 500.

(3) The composition forming a yellowing-free, low-hardness polyurethane elastomer according to (1), wherein the isocyanate-terminated prepolymer (A) is an isocyanate-terminated allophanate obtained by a urethanation reaction and an allophanation reaction between hexamethylene diisocyanate and a glycol having an alkyl group as a side chain and having a molecular weight no greater than 500.

(4) A method for producing a yellowing-free, low-hardness polyurethane elastomer, wherein the isocyanate-terminated prepolymer (A) and the polyester polyol (B) according to any one of (1) to (3) by are mixed and cured by a hydroxyl/isocyanate mole ratio (α value) ranging from 2 to 5 in the absence of plasticizer.

### Effect of the Invention

The present invention makes it possible to provide a thermosetting polyurethane elastomer that is highly transparent and non-yellowing, having therefore excellent designability, and has also low hardness without using any plasticizer. The thermosetting polyurethane elastomer obtained in accordance with the present invention uses no plasticizer, and is hence free of bleeding. Moreover, although the polyurethane elastomer has low hardness, the surface thereof exhibits little tacky feel. Also, the polyurethane elastomer exhibits only small changes in hardness with temperature, and retains sufficient flexibility also at low temperatures.

### BEST MODES FOR CARRYING OUT THE INVENTION

The present invention is a composition forming a polyurethane elastomer, containing no plasticizer, and comprising (A) an isocyanate-terminated prepolymer, and (B) a polyester polyol, wherein the isocyanate-terminated prepolymer (A) is an isocyanate-terminated prepolymer having an average number of functional groups of 2.5 to 6 and is obtained by reacting hexamethylene diisocyanate with a glycol having an alkyl group as a side chain and having a molecular weight no greater than 500; and the polyester polyol (B) is a polyester polyol obtained from trimethylolpropane, 3-methyl-1,5-pentanediol and adipic acid, and has an average number of functional groups of 2.5 to 3.5 and a number average molecular weight of 800 to 5,000.

When the average number of functional groups of the isocyanate-terminated prepolymer (A) used in the present invention is below the lower limit, matter is likelier to migrate from the obtained polyurethane elastomer. This can be ascribed to insufficient cross-linking during curing of the composition capable of forming the polyurethane elastomer, and the accompanying formation of low-molecular weight oligomers and cyclic products. A low-hardness elastomer is also difficult to obtain when the average number of functional groups is excessively high.

The isocyanate content in the isocyanate-terminated prepolymer (A) used in the present invention ranges preferably from 10 to 30 wt %, more preferably from 15 to 25 wt %. The viscosity at 60° C. is preferably no greater than 1,000 mPa·s, and ranges preferably from 50 to 500 mPa·s.

When the glycol that reacts with hexamethylene diisocyanate contains no alkyl groups in a side chain, compatibility with the polyester polyol decreases, and the viscosity of the obtained isocyanate-terminated prepolymer tends to increase, which is likely to make subsequent molding more difficult.

Specific examples of glycol having an alkyl group as a side chain to react with hexamethylene diisocyanate include 1,2-propanediol, 1,2-butanediol, 1,3-butanediol, 2-methyl-1,3-propanediol, 2,3-butanediol, 3-methyl-1,5-pentanediol, neopentyl glycol, 2,2-dimethylolheptane and the like.

Preferably, the isocyanate-terminated prepolymer (A) of the present invention is (a) or (b) below:
(a) an isocyanate-terminated urethane-isocyanurate prepolymer obtained by a urethanation reaction and an isocyanuration reaction between hexamethylene diisocyanate and a glycol having an alkyl group as a side chain and having a molecular weight no greater than 500
(b) an isocyanate-terminated allophanate prepolymer obtained by a urethanation reaction and an allophanation reaction between hexamethylene diisocyahate and a glycol having an alkyl group as a side chain and having a molecular weight no greater than 500.

In the present invention there may also be concomitantly used polyisocyanates other than the above, as the case may require. Examples thereof include, for instance, aromatic diisocyanates such as m-phenylene diisocyanate, p-phenylene diisocyanate, 4,4′-diphenyl diisocyanate, 1,5-naphthalene diisocyanate, 4,4′-diphenylmethane diisocyanate, 2,4- or 2,6-tolylene diisocyanate, 4,4′-toluidine diisocyanate or 4-4′-diphenyletherdiisocyanate; an araliphatic diisocyanate such as 1,3- or 1,4-xylylene diisocyanate or a mixture thereof; an aliphatic diisocyanate such as trimethylene diisocyanate, tetramethylene diisocyanate, pentamethylene diisocyanate, 1,2-propylene diisocyanate, 1,2-butylene diisocyanate, 2,3-butylene diisocyanate, 1,3-butylene diisocyanate, 2,4,4- or 2,2,4-trimethylhexamethylene diisocyanate or 2,6-diisocyanate methyl caproate; an alicyclic diisocyanate such as 1,3-cyclopentene diisocyanate, 1,4-cyclohexane diisocyanate, 1,3-cyclohexane diisocyanate, isophorone diisocyanate, 4,4′-methylenebis(cyclohexylisocyanate), methyl-2,4-cyclohexane diisocyanate, methyl-2,6-cyclohexane diisocyanate or 1,4-bis(isocyanatemethyl)cyclohexane; as well as carbodiimide modified polyisocyanates, biuret modified polyisocyanates, allophanate modified polyisocyanates, urethodione modified polyisocyanates and isocyanurate modified polyisocyanates of the foregoing diisocyanates.

The polyester polyol (B) used in the present invention is a polyester polyol obtained from trimethylolpropane, 3-methyl-1,5-pentanediol and adipic acid, and has an average number of functional groups of 2.5 to 3.5 and a number average molecular weight of 800 to 5,000. When the average number of functional groups is below the lower limit, matter is likelier to migrate from the obtained polyurethane elastomer. This can be ascribed to insufficient cross-linking during curing of the composition forming the polyurethane elastomer, and the accompanying formation of low-molecular weight oligomers and cyclic products. A low-hardness elastomer is also more difficult to obtain when the average number of functional groups is excessively high.

Compounds containing an active hydrogen group other than the above polyester may also be used mixed with the polyester polyol, as the case may require. Examples of compounds containing active hydrogen groups other than the above polyester include, for instance, low molecular polyhydric alcohols such as ethylene glycol, propanediol, butanediol, pentanediol, 1,6-hexanediol, 3-methyl-1,5-pentanediol, neopentyl glycol, cyclohexane dimethanol, 1,4-bis(2-hydroxyethoxy)benzene, diethylene glycol, dipropylene glycol, glycerin, trimethylolpropane, 1,2,6-hexanetriol, 1,2,4-butanetriol, diglycerol, pentaerythritol, trimethylolethane, triisopropanolamine, triethanolamine or diisopropanolamine; polyester polyols other than the above polyester polyol; as well as polyether polyols, polycarbonate polyols, polyolefin polyols and the like. The foregoing can be used singly or in mixtures of two or more.

A method for producing the yellowing-free, low-hardness polyurethane elastomer of the present invention involves mixing, and curing, the isocyanate-terminated prepolymer (A) and the polyester polyol (B) at a hydroxyl/isocyanate mole ratio (a value) ranging from 2 to 5 without using a plasticizer. Preferred blending ratios (a values) of isocyanate-terminated prepolymer (A) and polyester polyol (B) are hydroxyl/isocyanate=2.5 to 4.5 (equivalence ratio), in particular 2.8 to 4.3. When the a value is too low, it is difficult to impart low hardness to the obtained polyurethane elastomer, whereas too high an α value may result in a tacky surface in the obtained polyurethane elastomer, whose strength tends to drop. To produce the polyurethane elastomer, the isocyanate-terminated prepolymer (A) and the polyester polyol (B) are mixed at 40 to 85° C. and the resulting mixed liquid is poured into a pre-heated mold and is cured at a temperature ranging from room temperature to 160° C. Optionally, the mixture may be further left to settle at 60 to 160° C. The polyurethane elastomer thus obtained exhibits non-yellowing, transparency and low hardness (Asker C hardness (25° C.): 5 to 15, Asker C hardness (0° C.): 8 to 20). The hardness of the polyurethane elastomer exhibits low temperature dependence, and loss of flexibility at low temperature is also small. The obtained polyurethane elastomer has the further advantage of being bleeding-free, since no plasticizer is used.

The present invention is characterized in not blending the plasticizer. The term plasticizer denotes herein a compound that has a viscosity-reducing effect, and does not have a reactive group. Examples of plasticizers include, for instance, phthalates such as bis(2-ethylhexyl)phthalate or dibutyl phthalate; and aliphatic carboxylates such as dioctyl adipate, diisodecyl succinate, dibutyl sebacate or butyl oleate.

Besides a reaction catalyst and a plasticizer, other additives can be used in the present invention as the case may require upon curing, for instance antifoamers, foaming agents, defoaming agents, release agents, fire retardants, fillers, bulking agents, coloring agents, antioxidants, UV absorbents, light stabilizers and the like.

Examples of reaction catalysts include, for instance, organotin compounds such as dibutyltin dilaurate, dioctyltin dilaurate, dibutyltin dioctoate or tin 2-ethylhexanoate; iron compounds such as iron acetylacetonate or ferric chloride; or tertiary amines such as triethylamine or triethylenediamine. Preferred among the foregoing are organotin compounds.

The addition amount of the catalyst ranges preferably from 0.0001 to 0.1 parts by weight, in particular 0.001 to 0.01 parts by weight, relative to a total 100 parts by weight of isocyanate-terminated prepolymer (A) and polyester polyol (B). When the addition amount of catalyst is smaller than 0.0001 parts by weight, the time elapsed until the molded article can be demolded becomes longer, whereas an addition amount in excess of 0.1 parts by weight results in an excessively short pot life after mixing of the reaction components, all of which is undesirable.

Examples of fillers and bulking agents include, for instance, carbon black, aluminum hydroxide, calcium carbonate, titanium oxide, silica, glass fibers, bone meal, wood flour, fiber flakes and the like. Examples of flame retardants include, for instance, chloro alkyl phosphates, dimethyl methylphosphonate, ammonium polyphosphate and organic bromine compounds. Examples of demolding agents include, for instance, waxes, soaps, silicone oil and the like.

The polyurethane elastomer obtained in accordance with the present invention is particularly useful in fields where low hardness and designability are required, for instance rollers, shock absorbing members for office automation equipment, buffer members for optical materials, surface protection members in labels and displays, automotive components, various general merchandise, sports articles, vibration proofing and seismic isolation materials, medical mats, shoe insoles, supporters and the like.

### Examples

Examples of the present invention are explained below, although the invention is in no way meant to be limited to or by the examples. In the examples and comparative examples, “parts” and “%” denote “parts by weight” and “wt %”, respectively.

### Synthesis of an isocyanate-terminated prepolymer

### Synthesis Example 1

A reactor equipped with agitator, thermometer, condenser and nitrogen gas infusing pipe was charged with 900 parts of hexamethylene diisocyanate and 7.2 parts of 1,3-butanediol. The reactor was purged with nitrogen, was heated to a reaction temperature of 80° C. under stirring, and the reaction was left to proceed for 2 hours. The isocyanate content in the reaction solution, measured at that time, was 48.9%. Next, 0.2 parts of potassium caprate as an isocyanuration catalyst, and 1 part of phenol as a co-catalyst, were added to the reactor. The isocyanuration reaction proceeded for 5 hours at 60° C., and then 0.13 kg of phosphoric acid as a stopper, was added to the reaction solution, with stirring at 80° C. for 1 hour. Thereafter, unreacted HDI was removed through thin film distillation at 120° C. and 0.04 kPa, to yield an isocyanate-terminated urethane-isocyanurate prepolymer (HDI-TR) having an average number of functional groups of 3.5, an isocyanate content of 21.3% and a 25° C. viscosity of 2,100 mPa·s.

### Synthesis Example 2

A reactor identical to that of Synthesis example 1 was charged with 950 parts of hexamethylene diisocyanate and 50 parts of 3-methyl-1,5-propanediol. The reactor was purged with nitrogen, and was heated at a reaction temperature of 80° C. under stirring. The reaction was left to proceed for 2 hours. An FT-IR analysis of the reaction product revealed an absence of hydroxyl groups. Next, 0.2 parts of a zirconium-based catalyst (trade name: zirconyl octylate, by Daiichi Kigenso Kagaku Kogyo) were added, and the reaction was left to proceed for 4 hours at 110° C. An FT-IR and ¹³C-NMR analysis of the reaction product revealed an absence of urethane groups. Next, 0.01 kg of phosphoric acid were added to carry out a termination reaction for 1 hour at 50° C. The isocyanate content in the reaction product after the termination reaction was 40.4%. The reaction product was thin-film distilled at 130° C.×0.04 kPa to eliminate unreacted HDI, and yield an isocyanate-terminated allophanate prepolymer (HDI-ALP1) having an average number of functional groups of 4.8, an isocyanate content of 19.2%, and a 25° C. viscosity of 1,700 mPa·s.

### Synthesis Comparative Example

A reactor identical to that of Synthesis example 1 was charged with 975 parts of hexamethylene diisocyanate and 25 parts of isopropanol. The reactor was purged with nitrogen, and was heated at a reaction temperature of 80° C. under stirring. The reaction was left to proceed for 2 hours. An FT-IR analysis of the reaction product revealed an absence of hydroxyl groups. Next, 0.2 parts of a zirconium-based catalyst (trade name: zirconyl octylate, by Daiichi Kigenso Kagaku Kogyo) were added, and the reaction was left to proceed for 4 hours at 110° C. A FT-IR and ¹³C-NMR analysis of the reaction product revealed an absence of urethane groups. Next, 0.01 kg of phosphoric acid were added to stop the reaction for 1 hour at 50° C. The isocyanate content in the reaction product after the termination reaction was 40.4%. The reaction product was thin-film distilled at 130° C.×0.04 kPa to eliminate unreacted HDI, and yield an isocyanate-terminated allophanate prepolymer (HDI-ALP2) having an average number of functional groups of 2, an isocyanate content of 19.4%, and a 25° C. viscosity of 120 mPa·s.

### Examples 1 to 3, Comparative Examples 1 to 5

Isocyanate-terminated prepolymers and polyester polyols (or polyether polyol) were mixed with a catalyst (DOTDL, 100 ppm relative to resin component) in the combinations given in Table 1, at 80° C. After thorough defoaming under reduced pressure at 5 mmHg, the resulting products were cast into a mold heated beforehand at 80° C. Curing was then carried out for 1 hour at 80° C., followed by standing for 72 hours at room temperature, to prepare 2 mm- and 4 mm-thick urethane elastomer sheets.
* DOTDL: dioctyltin dilaurate, urethanation catalyst

### Comparative Example 6

Evaluation was performed using a commercially available plasticized PVC sheet instead of a polyurethane elastomer.

TABLE 1

| | Example | | | Comparative example | | | | | |
|---|---|---|---|---|---|---|---|---|---|
| | 1 | 2 | 3 | 1 | 2 | 3 | 4 | 5 | 6 |
| isocyanate-terminated | | | | | | | | | |
| prepolymer | | | | | | | | | |
| HDI-TR | ∘ | | ∘ | ∘ | ∘ | ∘ | ∘ | | |
| HDI-ALP1 | | ∘ | | | | | | | |
| HDI-ALP2 | | | | | | | | ∘ | |
| Polyester polyol | | | | | | | | | |
| PES-1 | ∘ | ∘ | | | | | | ∘ | |
| PES-2 | | | ∘ | | | | | | |
| PES-3 | | | | ∘ | | | | | |
| PES-4 | | | | | | ∘ | | | |
| PES-5 | | | | | | | ∘ | | |
| Polyether polyol | | | | | | | | | |
| PET-1 | | | | | ∘ | | | | |
| Other resin | | | | | | | | | |
| Plasticized PVC resin | | | | | | | | | ∘ |
| Blending ratio | 3.1 | 3.8 | 3.5 | 3.3 | 3.0 | 2.8 | 1.9 | 1.7 | — |
| (OH/NCO mole ratio) | | | | | | | | | |
| Property evaluation | | | | | | | | | |
| Primary evaluation | | | | | | | | | |
| Migration | ∘ | ∘ | ∘ | ∘ | x | ∘ | x | x | x |
| Tack | ∘ | ∘ | ∘ | ∘ | ∘ | ∘ | Δ | x | ∘ |
| Secondary evaluation | | | | | | | | | |
| Asker C hardness | 7/16 | 9/15 | 10/15 | 9/86 | Not | 8/40 | Not | Not | Not |
| (25° C./−5° C.) | | | | | tested | | tested | tested | tested |
| Low-temperature stability | ∘ | ∘ | ∘ | x | | x | | | |
| Total transmittance (%) | 93.3 | 92.9 | 93.5 | 93.0 | | 92.7 | | | |
| Strength at break (MPa) | 0.23 | 0.14 | 0.36 | 0.38 | | 0.52 | | | |
| Elongation at break (%) | 380 | 200 | 500 | 340 | | 380 | | | |
| Tear strength (kN/m) | 1.03 | 1.05 | 1.62 | 1.62 | | 1.18 | | | |

### Examples 1 to 3, in Table 1

PES-1: polyester polyol obtained from TMP, MPD and adipic acid.

number average molecular weight=1,000

average number of functional groups=3
PES-2: polyester polyol obtained from TMP, MPD and adipic acid.

number average molecular weight=3,000

average number of functional groups=3
PES-3: polyester polyol obtained from TMP, 14BD and adipic acid.

number average molecular weight=1,000

average number of functional groups=3
PES-4: polyester polyol obtained from TMP, MPD and adipic acid.

number average molecular weight=500

average number of functional groups=3
PES-5: polyester polyol obtained from MPD and adipic acid.

number average molecular weight=1,000

average number of functional groups=2
PET-1: polyether polyol obtained through ring-opening addition of PO to glycerol

number average molecular weight=1,000

average number of functional groups=3
*TMP: trimethylol propane
MPD: 3-methyl-1,5-pentanediol
14BD: 1,4-butanediol
PO: propylene oxide

[Evaluation Method]

Property evaluation included a primary screening test for evaluation of tack and migration. The samples that passed the screening were then subjected to hardness measurement, a tensile test and so forth. The test methods were as follows:
Migration: Glass-sandwiched test samples (4 mm-thick sheets: 50 mm×40 mm×4 mm) were subjected to a load of 1N/cm², and were left to stand thus for 24 hours in a 80° C.×60% RH atmosphere. The test samples were then removed, and the presence of matter migration on the glass surface was evaluated visually.

∘: No migration of matter onto glass surface

×: Migration of matter onto glass surface
Tack: Elastomer sheets 4 mm thick were touched with the hands, to evaluate the presence of tackiness at room temperature.

⊚: No tacky feel

∘: Very slight tacky feel

Δ: Slight tacky feel

×: Extreme tacky feel
Asker C hardness: Elastomer sheets 4 mm thick were measured and evaluated in accordance with JIS K7312 except for the measurement temperature.
Low-temperature stability: It was evaluated based on the difference between Asker C hardness at 25° C. and −5° C.

∘: 10 or less

Δ: 11 to 20

×: 20 or more
Total light transmittance: It was evaluated in accordance with JIS K7361 using 2 mm-thick sheets.
Strength at break, elongation at break: It was measured in accordance with JIS K7312.
Tear strength: It was measured in accordance with JIS K7312.

Table 1 shows that the polyurethane elastomers obtained in accordance with the present invention were free of migration phenomena, exhibited little changes in hardness with temperature, and preserved flexibility also at low temperatures. On the other hand, a polyurethane elastomer obtained from a polyether polyol (Comparative example 2), polyurethane elastomers from polyester polyols and polyisocyanates having few functional groups (Comparative examples 4 and 5), as well as a plasticized PVC resin (Comparative example 6) exhibited poor migration properties, and were not further evaluated. An elastomer obtained from a polyester using no glycol having an alkyl group as a side chain (Comparative example 1) exhibited substantial changes in hardness with temperature, and loss of flexibility at low temperature. An elastomer from a polyester having a low number-average molecular weight (Comparative example 3) exhibited substantial changes in hardness with temperature.

1. A composition forming a yellowing-free, low-hardness polyurethane elastomer containing no plasticizer and comprising (A) an isocyanate-terminated prepolymer and (B) a polyester polyol as essential components,
wherein the isocyanate-terminated prepolymer (A) is an isocyanate-terminated prepolymer that is obtained by reacting hexamethylene diisocyanate with a glycol having an alkyl group as a side chain and having a molecular weight no greater than 500, and that has an average number of functional groups of 2.5 to 6, and
the polyester polyol (B) is a polyester polyol that is obtained from trimethylolpropane, 3-methyl-1,5-pentanediol and adipic acid, and has an average number of functional groups of 2.5 to 3.5 and a number average molecular weight of 800 to 5,000.

2. The composition forming a yellowing-free, low-hardness polyurethane elastomer according to claim 1, wherein the isocyanate-terminated prepolymer (A) is an isocyanate-terminated urethane-isocyanurate prepolymer obtained by a urethanation reaction and an isocyanuration reaction between hexamethylene diisocyanate and a glycol having an alkyl group as a side chain and having a molecular weight no greater than 500.

3. The composition forming a yellowing-free, low-hardness polyurethane elastomer according to claim 1, wherein the isocyanate-terminated prepolymer (A) is an isocyanate-terminated allophanate obtained by a urethanation reaction and an allophanation reaction between hexamethylene diisocyanate and a glycol having an alkyl group as a side chain and having a molecular weight no greater than 500.

4. A method for producing a yellowing-free, low-hardness polyurethane elastomer, wherein the isocyanate-terminated prepolymer (A) and the polyester polyol (B) according to claim 1 are mixed and cured by a hydroxyl/isocyanate mole ratio (α value) ranging from 2 to 5 in the absence of plasticizer.
